(19) United States
(12) Patent Application Publication
(10) Pub. No.: US 2006/0095321 A1
(43) Pub. Date: May 4, 2006

(54) Method and apparatus for promotion management

(76) Inventors: Jianpeng Shi, San Jose, CA (US); Joseph Galang Evasco, Union City, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/980,130

(22) Filed: Nov. 1, 2004

(51) Int. Cl. G06Q 30/00

(52) U.S. Cl. 705/14

(57) ABSTRACT

One embodiment disclosed relates to a method of managing promotions. A determination is made that a promotion is activated, and a product database, including an entry with information on the promotion, is accessed. The promotion information is incorporated into a web page template. The promotion information is also incorporated into a screen template of an order management interface in synchronization with the incorporation into the web page template. In an exemplary embodiment, the TOMI screen template consolidates information for various promotions to a particular end-user type onto a single screen. Other embodiments are also disclosed.

### FIELD OF THE INVENTION

The present disclosure relates generally to computer software, and more particularly, to computer software for call centers and web sites.

### DESCRIPTION OF THE BACKGROUND ART

In recent years, call centers for product sales frequently receive calls from end users that have access to public web sites for the products. For example, the call center may be for a company that sells computer equipment, consumer electronics, networking gear, software, and other products.

Problems or difficulties may occur if the information available to the call center agent does not correspond exactly to the information presented to the end user via the public web site. In particular, information on promotions and sales may be out-dated or out-of-synchronization, and such promotional type information may not be readily located by the call center agent.

It is highly desirable to improve computer software. In particular, it is highly desirable to improve computer software to facilitate and manage telephone orders through call centers.

### SUMMARY

One embodiment of the invention pertains to a method of managing promotions. A determination is made that a promotion is activated, and a product database, including an entry with information on the promotion, is accessed. The promotion information is incorporated into a web page template. The promotion information is also incorporated into a screen template of an order management interface in synchronization with the incorporation into the web page template. In an exemplary embodiment, the synchronization between the interface screen template and the web page template is such that the same promotion information, and any changes thereto, are available at a same time to both a sales agent using the order management interface and an end user viewing a publicly-viewable web site. In an exemplary embodiment, the interface screen template consolidates information for various promotions to a particular end-user type onto a single screen.

Another embodiment pertains to a system configured to manage promotions. The system includes at least a product database, a web server, an order management server, and a station. The product database includes an entry with information on the promotion. The web server is configured to serve a web page, and the order management server is configured to provide an interface screen to the station. Computer-readable code is configured to incorporate the promotion information into the web page and to incorporate the promotion information into the interface screen in synchronization with each other. In an exemplary embodiment, the interface screen consolidates information for various promotions to a particular end-user type onto a single screen.

Other embodiments are also disclosed.

### BRIEF DESCRIPTION OF THE DRAWINGS

FIG. 1 is a schematic diagram of a system configured to manage promotions in accordance with an embodiment of the invention.

FIG. 2A is a high-level flow chart showing a procedure for activating and deactivating a promotion in accordance with an embodiment of the invention.

FIG. 2B is a flow chart depicting a procedure for making live a promotion in a synchronized and coordinated manner in accordance with an embodiment of the invention.

FIG. 2C is a flow chart depicting a procedure for removing a promotion in a synchronized and coordinated manner in accordance with an embodiment of the invention.

FIG. 3 is a printout of an exemplary high-level screen of a telephone order management interface (TOMI) in accordance with an embodiment of the invention.

FIG. 4 is a printout of an exemplary web page for general end users in accordance with an embodiment of the invention.

FIG. 5 is a printout of an exemplary web page for employee end users in accordance with an embodiment of the invention.

FIG. 6 is a printout of an exemplary TOMI screen consolidating promotions for general end users in accordance with an embodiment of the invention.

FIG. 7 is a printout of an exemplary TOMI screen consolidating promotions for employee end users in accordance with an embodiment of the invention.

### DETAILED DESCRIPTION

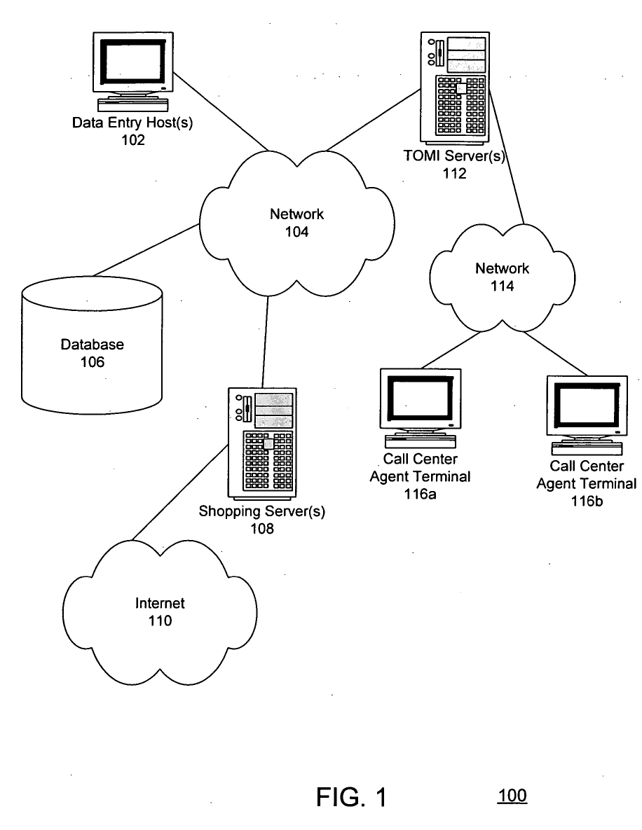

FIG. 1 is a schematic diagram of a system 100 configured to manage promotions in accordance with an embodiment of the invention. As shown, the system 100 may include one or more data entry hosts 102 interconnected via a network 104 to a database 106. The database 106 may be provided via a computer server and database software. The database 106 may be configured to include various information regarding products for sale.

The system 100 may also include one or more shopping servers 108 and one or more telephone order management interface (TOMI) servers 112. The shopping server or servers 108 may be configured to provide a shopping web site for the products to hosts for end users (not illustrated) via the Internet 110. The TOMI server or servers 112 may be configured to provide a telephone order management interface via a network 114 to call center agent terminals or workstations 116.

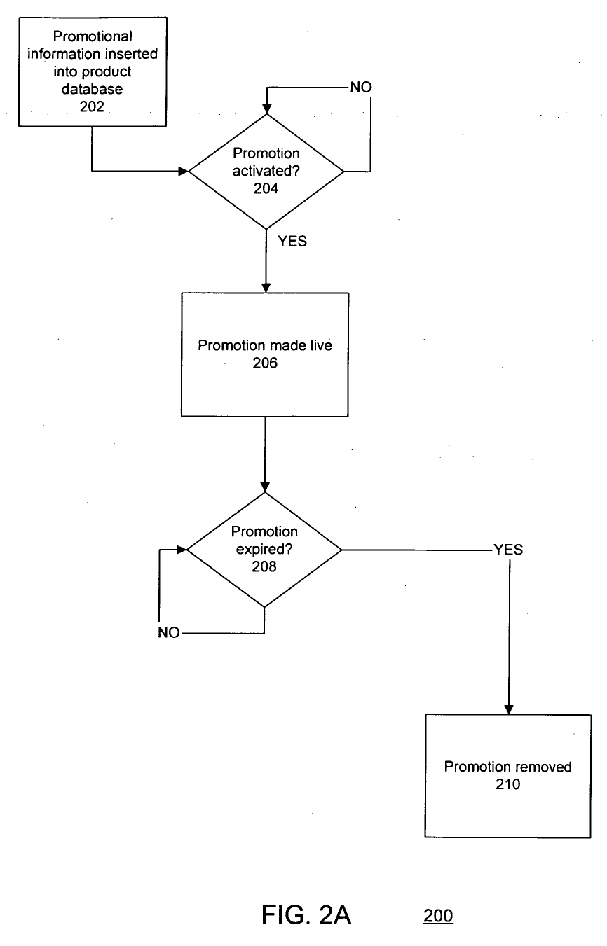

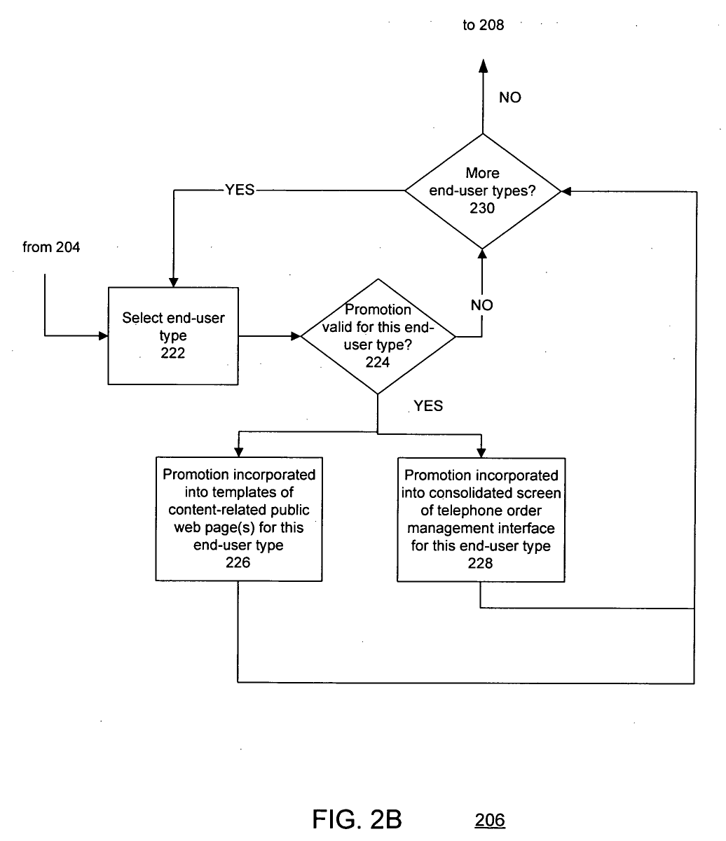

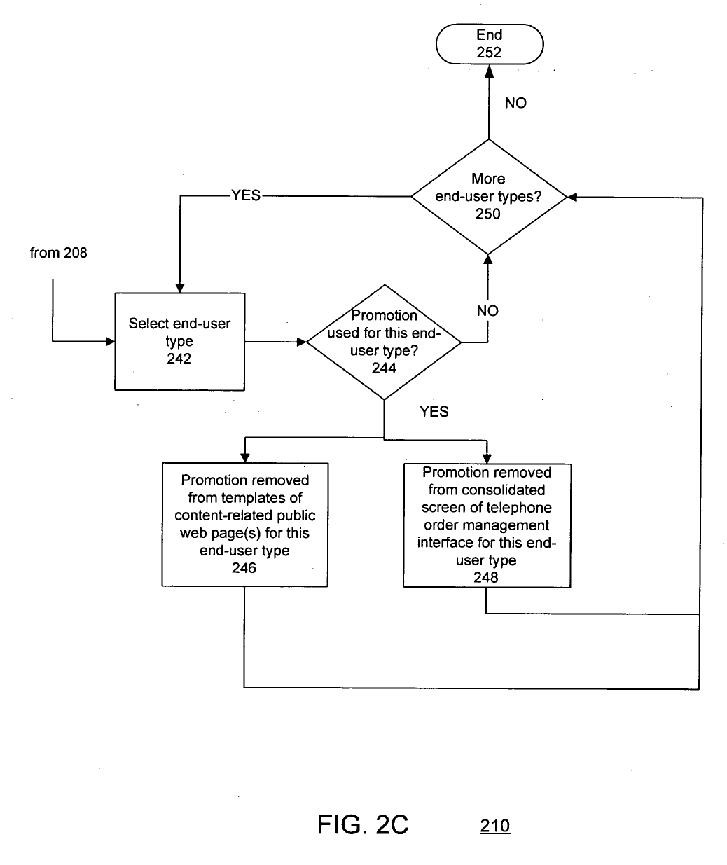

FIG. 2A is a high-level flow chart showing a procedure 200 for activating and deactivating a promotion in accordance with an embodiment of the invention. The procedure 200 may be implemented using software in the system. The software may reside on a computer system having access to the product database 106. The computer system may comprise, for example, one of the servers shown in FIG. 1.

As a preliminary step, information related to the promotion may be inserted (202) into the product database 106, for example, by marketing or other personnel via a data entry host or workstation 102. The promotional information entered may include data such as, for example, the product on promotion, an activation date, an expiration date, pricing for the promotion, a graphic or multimedia file for the promotion, valid end-user types for the promotion, and other data.

In accordance with this embodiment, the procedure waits until a promotion is activated (204). A determination of when the promotion is activated may be done by examination of the activation date for that promotion in the database 106. When the promotion is activated, then the promotion is made live (206). In accordance with an embodiment of the invention, the promotion may be made live on both a publicly accessible website (or websites) and on a telephone order management interface (or interfaces). An exemplary procedure for making a promotion live (206) is discussed below in relation to FIG. 2B.

Once the promotion is live or activated, the procedure waits until the promotion expires (208). A determination of when the promotion expires may be done by examination of the expiration date for that promotion in the database 106. When the promotion expires, then the promotion is removed (210). In accordance with an embodiment of the invention, the promotion may be removed from both a publicly-accessible website (or websites) and from a telephone order management interface (or interfaces). An exemplary procedure for removing a promotion (210) is discussed below in relation to FIG. 2C.

FIG. 2B is a flow chart depicting a procedure for making a promotion live (206) in a synchronized and coordinated manner in accordance with an embodiment of the invention. In accordance with this embodiment, promotions may be valid for some types of end users while being invalid for other types of end users. In other words, the promotions may be specific to one or more end-user types. For example, end-user types may include a general end-user type as a default for end users who are not members of more specific or exclusive types. Another end-user type may include as its members the employees of the company selling the product. Other end-user types may include employees of partner companies, or employees of a select group of “premier” partner companies. Various other end-user types may also be used.

In accordance with the procedure 206, one of the end-user types is selected (222). A determination may then be made as to whether the activated promotion is valid for this end-user type (224). This determination may be made, for example, by accessing the promotion entry in the product database 106.

If the database 106 indicates that the promotion is invalid for this end-user type, then the procedure 206 determines if there are more end-user types to process (230). If there are, then the next end-user type is selected (222). Otherwise, the procedure 206 ends such that the higher-level procedure 200 then waits for the promotion to expire (208).

If the database 106 indicates that the promotion is valid for this end-user type, then the procedure 206 goes forward with at least the following two steps. The promotion is incorporated into templates of the content-related public web page(s) for this end-user type (226), and the promotion is incorporated into a consolidated screen of the telephone order management interface (TOMI) for this end-user type (228). The incorporation of the valid promotion into both the publicly-accessible content-related web pages and the consolidated TOMI screen advantageously maintains the two in synchronization and also advantageously facilitates access to all valid promotions for this end-user type to the call center agent. Then, the procedure 206 may move on to determine if there are more end-user types to process (230). If there are, then the next end-user type is selected (222). Otherwise, the procedure 206 ends such that the higher-level procedure 200 then waits for the promotion to expire (208).

FIG. 2C is a flow chart depicting a procedure for removing a promotion (210) in a synchronized and coordinated manner in accordance with an embodiment of the invention. In accordance with this procedure, one of the end-user types is selected (242). A determination may then be made as to whether the activated promotion is being used for or applied to this end-user type (244). This determination may be made, for example, by accessing the promotion entry in the product database 106.

If the database 106 indicates that the promotion is being used for this end-user type, then the procedure determines if there are more end-user types to process (250). If there are, then the next end-user type is selected (242). Otherwise, the procedure 210 ends (252).

If the database 106 indicates that the promotion is being used for this end-user type, then the procedure 210 goes forward with at least the following two steps. The promotion is removed from templates of the content-related public web page(s) for this end-user type (246), and the promotion is also removed from the consolidated screen of the telephone order management interface (TOMI) for this end-user type (248). The removal of the active promotion into both the publicly-accessible content-related web pages and the consolidated TOMI screen advantageously maintains the two in synchronization. Then, the procedure 210 may move on to determine if there are more end-user types to process (250). If there are, then the next end-user type is selected (242). Otherwise, the procedure 210 ends (252).

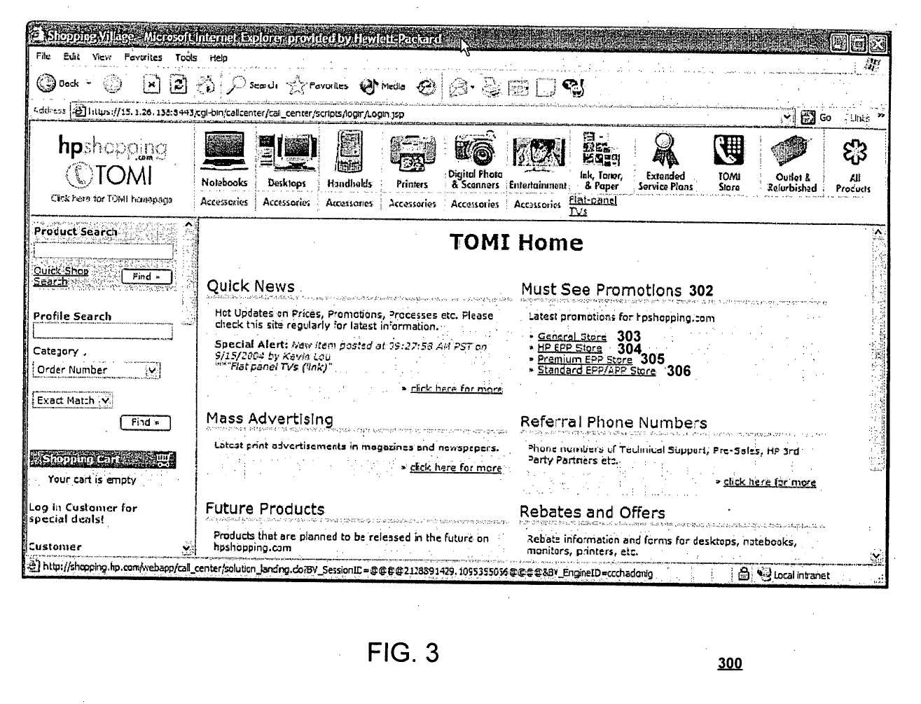

FIG. 3 is a printout of an exemplary high-level screen 300 of a telephone order management interface (TOMI) in accordance with an embodiment of the invention. Such a TOMI site is accessible to call center agents. In this particular example, the TOMI site is for a call center supporting hpshopping.com.

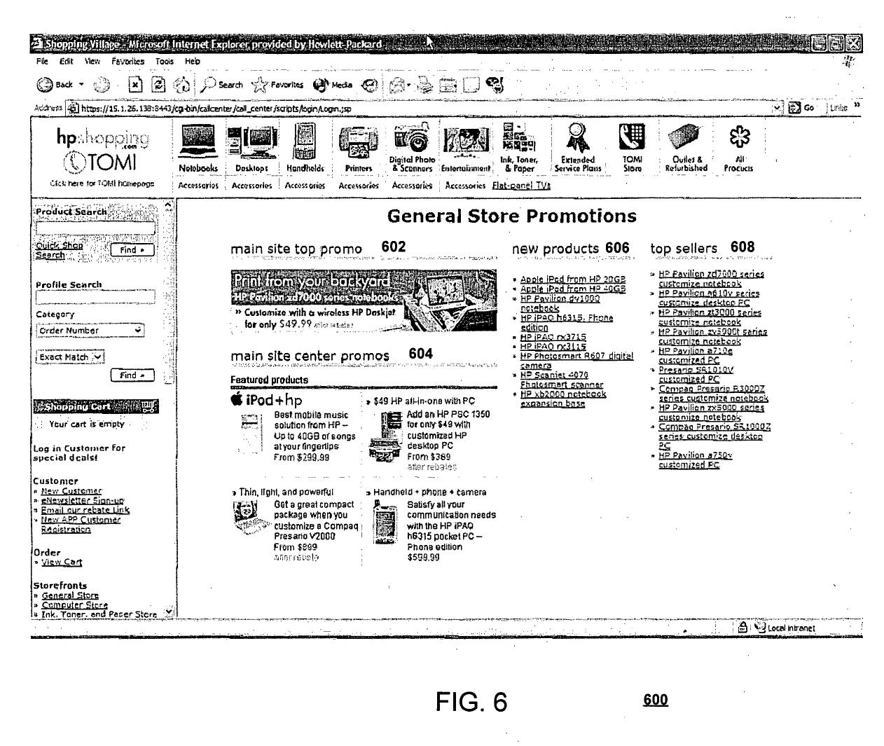

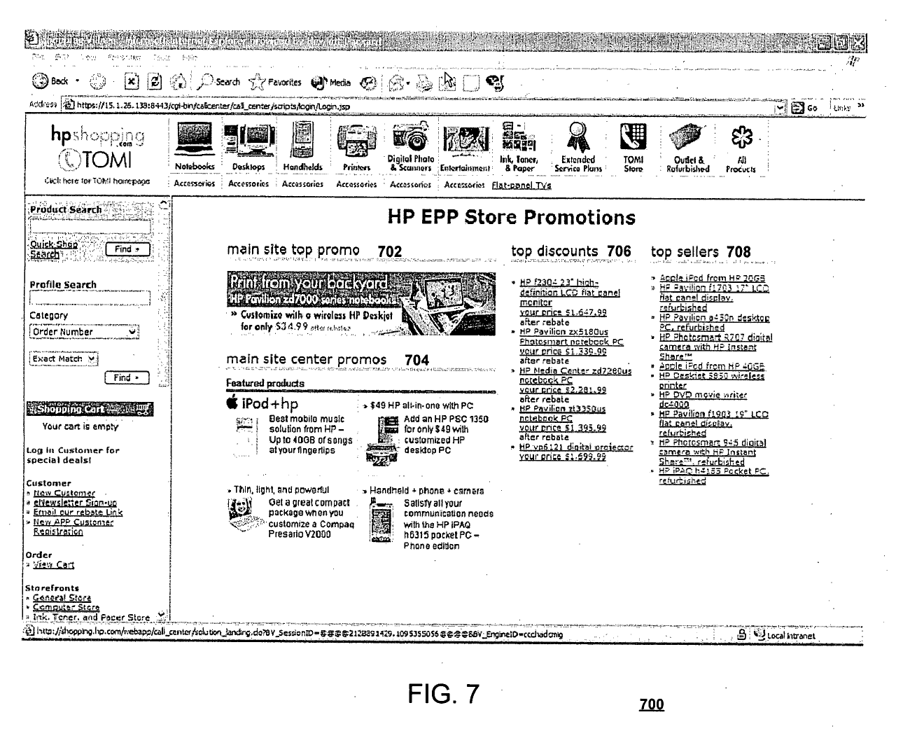

This exemplary high-level screen includes a section or area 302 for promotions (“Must See Promotions”). This promotion section includes links 303, 304, 305, and 306 to consolidated promotion screens for each of four end-user types “General Store”, “HP EPP Store”, “Premium EPP Store”, and “Standard EPP/APP Store”, respectively. The consolidated promotion screen 600 for the “General Store” is shown in FIG. 6 and described below in relation thereto. The consolidated promotion screen 700 for the “HP EPP Store” is shown in FIG. 7 and described below in relation thereto. These end-user types and associated screens are disclosed as illustrative examples.

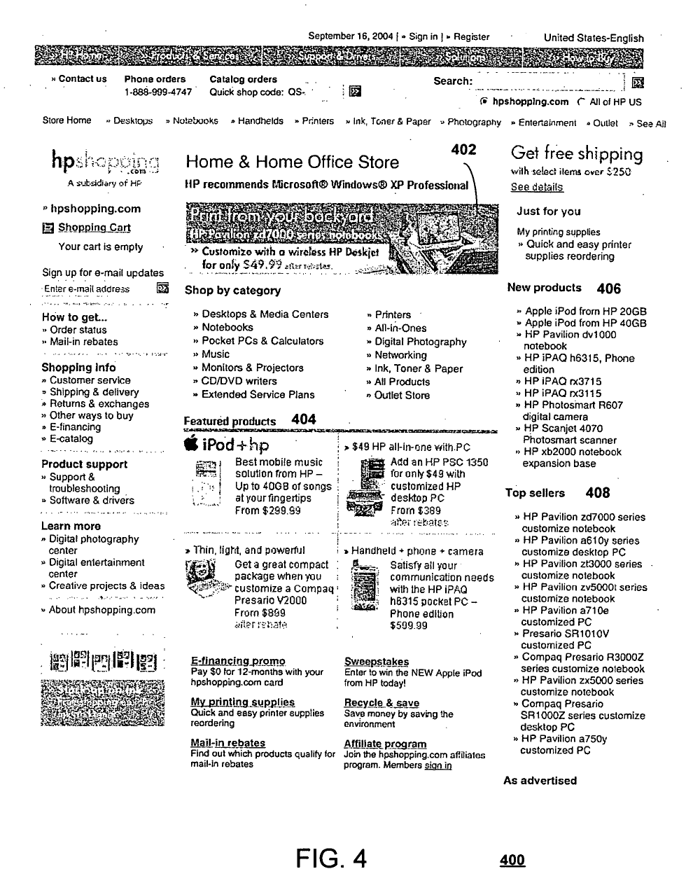

FIG. 4 is a printout of an exemplary web page 400 for general end users in accordance with an embodiment of the invention. In this example, the web page 400 is a publicly-accessible page from the web site for hpshopping.com. The exemplary page is configured to include various sections, including sections with “How to get . . . ” information, “Shopping info”, “Product support”, and so on. Among the various sections are several promotional areas, including a main site top promo area 402, a “featured products” area 404, a “new products” area 406, and a “top sellers” area 408. These promotional areas or sections comprise promotional information that is incorporated in block 226 of FIG. 2B into the web page for general end-users.

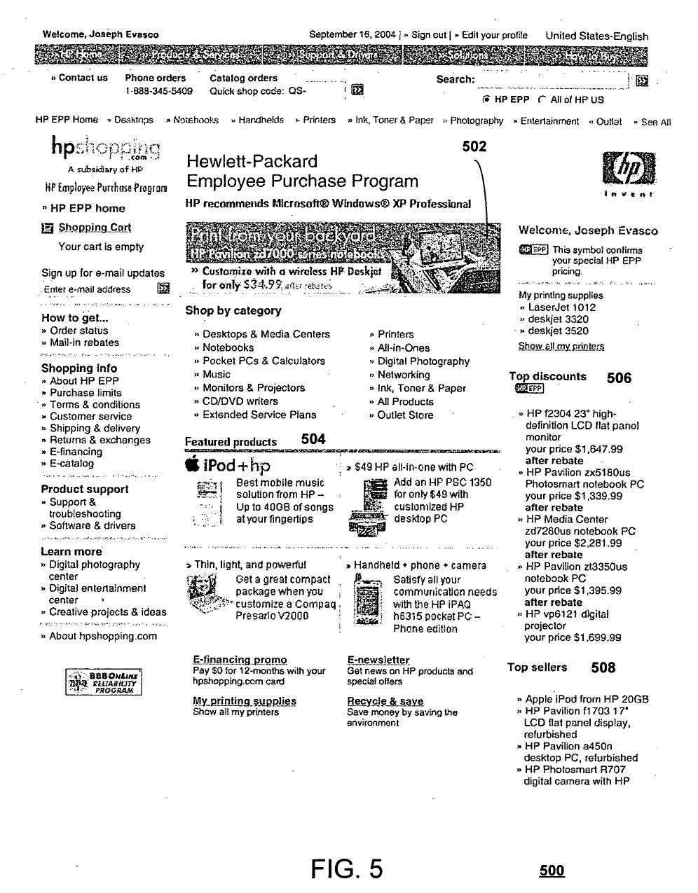

FIG. 5 is a printout of an exemplary web page 500 for employee end users in accordance with an embodiment of the invention. In this example, the web page 500 is an HP employee-accessible page from the web site for hpshopping.com. In other words, only end users that are HP employees are given the privilege of accessing this site. The exemplary page is configured to include various sections, including sections with “How to get . . . ” information, “Shopping info”, “Product support”, and so on. Among the various sections are several promotional areas, including a main site top promo area 502, a “featured products” area 504, a “top discounts” area 506, and a “top sellers” area 508. These promotional areas or sections comprise promotional information that is incorporated in block 226 of FIG. 2B into the web page for HP employee end-users.

FIG. 6 is a printout of an exemplary TOMI screen 600 consolidating promotions for general end users in accordance with an embodiment of the invention. In this example, the TOMI screen 600 is a private screen accessible to call center agents for hpshopping.com, where the screen is used to support general end users. The exemplary screen is configured to consolidate the various promotions available to this type of end user so as to facilitate access to the promotions by the call center agent. Here, the consolidated promotions include promotions in the “main site top promo” 602, the main site center promos” 604, the “new products” 606, and the “top sellers” 608. In this case, these promotional sections 602, 604, 606, and 608 in the TOMI screen of FIG. 6 correspond to the promotional areas 402, 404, 406, and 408, respectively, in the web page of FIG. 4. This screen 600 comprises promotional information that is incorporated in block 228 of FIG. 2B into the TOMI screen for call center agents to support general end-users.

FIG. 7 is a printout of an exemplary TOMI screen 700 consolidating promotions for employee end users in accordance with an embodiment of the invention. In this example, the TOMI screen 700 is a private screen accessible to call center agents for hpshopping.com, where the screen is used to support HP employee end users. The exemplary screen is configured to consolidate the various promotions available to this type of end user so as to facilitate access to the promotions by the call center agent. Here, the consolidated promotions include promotions in the “main site top promo” 702, the main site center promos” 704, the “top discounts” 706, and the “top sellers” 708. In this case, these promotional sections 702, 704, 706, and 708 in the TOMI screen of FIG. 7 correspond to the promotional areas 502, 504, 506, and 508, respectively, in the web page of FIG. 5. This screen 700 comprises promotional information that is incorporated in block 228 of FIG. 2B into the TOMI screen for call center agents to support HP employee end-users.

The above-disclosed method and apparatus for telephone order management has various advantages. In one exemplary embodiment, it advantageously allows all promotions to be accessible in one central location for ease of use and ease of navigation by a call center agent. In this exemplary embodiment, the central location may comprise a single screen of an order management interface that consolidates all promotions pertaining to a particular end-user type.

It also advantageously allows all promotions to be end-user type (i.e. customer type) specific. Promotions are neatly separated for easy access per end-user type. This helps an agent to easily locate all promotions available for a specific user type, thus enhancing customer service and allowing for faster service. A design in another approach made it much more difficult for an agent to locate a particular promotion for a particular customer type.

It further advantageously allows promotions to be handled dynamically so as to be able to disable the promotion if an associated link is down or not accessible in the system. This prevents a promotional link from giving a “page not found” or similar error message by providing for the disabling of the bad link dynamically when the linked page(s) is (are) not accessible by the system. A design in another approach did not include a capability to handle dynamic enabling and disabling of links.

In the above description, numerous specific details are given to provide a thorough understanding of embodiments of the invention. However, the above description of illustrated embodiments of the invention is not intended to be exhaustive or to limit the invention to the precise forms disclosed. One skilled in the relevant art will recognize that the invention can be practiced without one or more of the specific details, or with other methods, components, etc. In other instances, well-known structures or operations are not shown or described in detail to avoid obscuring aspects of the invention. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

What is claimed is:

1. A method of managing promotions, the method comprising:
determining that a promotion is activated;
accessing a product database including an entry with information on the promotion;
incorporating the promotion information into a web page template; and
incorporating the promotion information into a screen template of an order management interface in synchronization with the incorporation into the web page template.

2. The method of claim 1, wherein the screen template consolidates information for various promotions to a particular end-user type onto a single screen.

3. The method of claim 1, wherein the order management interface comprises a telephone order management interface (TOMI).

4. The method of claim 1, wherein the promotion is determined to be activated starting at an activation time obtained from the entry in the product database.

5. The method of claim 1, further comprising determining that the promotion is expired.

6. The method of claim 6, further comprising, upon expiration of the promotion:
removing the promotion information from the web page template; and
removing the promotion information from the TOMI screen template in synchronization with the removal from the web page template.

7. The method of claim 5, wherein the promotion is determined to be expired starting at an expiration time obtained from the entry in the product database.

8. The method of claim 1, wherein the promotion is validated for a particular end-user type.

9. The method of claim 8, wherein the particular end-user type is from a group of types including a general end-user type and an employee end-user type.

10. The method of claim 8, wherein the web page template is specifically designed for the particular end-user type.

11. The method of claim 10, wherein the interface screen template is also specifically designed for the particular end-user type.

12. A system configured to manage promotions, the system comprising:
a product database including an entry with information on a promotion;
a web server configured to serve a web page;
an order management server configured to provide an interface screen;
computer-readable code configured to incorporate the promotion information into the web page and to incorporate the promotion information into the interface screen in synchronization with each other; and
a station configured to access the interface screen from the order management server.

13. The system of claim 12, wherein the interface screen consolidates information for various promotions to a particular end user type onto a single screen.

14. The system of claim 12, wherein the order management server comprises a telephone order management server.

15. The system of claim 14, wherein the station comprises a station at a call center.

16. The system of claim 12, further comprising computer-readable code configured to determine when the promotion is activated by obtaining an activation time from the entry in the product database.

17. The system of claim 16, further comprising computer-readable code configured to determine when the promotion is expired by obtaining an expiration time from the entry in the product database.

18. The system of claim 17, further comprising:
computer-readable code configured to remove the promotion information from the web page and from the interface screen in synchronization with each other upon expiration of the promotion.

19. The system of claim 12, wherein the entry in the product database indicates that the promotion is valid for a particular end-user type.

20. The system of claim 19, wherein the particular end-user type is from a group of types including a general end-user type and an employee end-user type.

21. The system of claim 19, wherein the web page is specifically designed for the particular end-user type.

22. The system of claim 21, wherein the interface screen is also specifically designed for the particular end-user type.
